(19) United States
(12) Patent Application Publication
(10) Pub. No.: US 2017/0004709 A1
(43) Pub. Date: Jan. 5, 2017

(54) SENSOR DEVICE FOR A PARKING LOT

(71) Applicant: Robert Bosch GmbH, Stuttgart (DE)

(72) Inventors: Stefan Nordbruch, Kornwestheim (DE); Rolf Nicodemus, Bietigheim-Bissingen (DE); Willi Scherer, Reutlingen (DE)

(21) Appl. No.: 15/196,502

(22) Filed: Jun. 29, 2016

(30) Foreign Application Priority Data
Jul. 1, 2015 (DE) 102015212316.2

(51) Int. Cl. G08G 1/14; G08B 21/12; G08B 17/10

(52) U.S. Cl. CPC G08G 1/14; G08B 17/10; G08B 21/12

(57) ABSTRACT

A sensor device for a parking lot, including a sensor system for detecting a fire and/or smoke and/or gas and at least one parking sensor for detecting an occupancy state of a parking position. A parking lot is also described.

### CROSS REFERENCE

The present application claims the benefit under 35 U.S.C. §119 of German Patent Application No. DE 102015212316.2 filed on Jul. 1, 2015, which is expressly incorporated herein by reference in its entirety.

### FIELD

The present invention relates to a sensor device for a parking lot. The present invention also relates to a parking lot.

### BACKGROUND INFORMATION

Fire alarms or smoke alarms normally designate technical devices or systems for triggering an alarm in the event of a fire or in the presence of smoke. Parking lots are usually equipped with fire alarms or smoke alarms.

Furthermore, there are systems for detecting whether or not a parking position is occupied. Such systems may be installed for example in the flooring of the parking position. Such systems may be installed on the flooring of the parking position, for example.

Such systems for detecting whether or not a parking position is occupied are installed separately from fire alarms or smoke alarms. This results in a substantial installation effort and costs time, for example. In particular, due to the separate installation, the systems and the fire alarms or the smoke alarms must have separate power and/or communication lines.

### SUMMARY

An object of the present invention is therefore to provide an efficient concept that is able to reduce an installation effort when installing a sensor system for detecting a fire and/or smoke and/or gas and at least one parking sensor for detecting an occupancy state of a parking position.

This objective may be attained by example embodiments of the present invention.

According to one aspect, an example sensor device for a parking lot is provided, including a sensor system for detecting a fire and/or smoke and/or gas and at least one parking sensor for detecting an occupancy state of a parking position.

According to another aspect, a parking lot is provided, including the sensor device according to the present invention.

The present invention thus comprises, in particular and among other things, providing a sensor device that is not only able to detect a fire and/or smoke and/or gas, but that furthermore is also able to detect an occupancy state of a parking position. This occurs by way of the parking sensor. This means in particular that the sensor device advantageously has a dual function: detecting whether a parking position is occupied or free and detecting a fire and/or smoke and/or gas. Thus it suffices to install only one single device, the sensor device, within a parking lot in order to have available both a fire and/or smoke and/or gas detection function as well as a parking position occupancy detection function. In particular, the technical advantage of an efficient and time-saving installation is achieved thereby. This is so in particular in comparison to the related art, according to which it was necessary to install two separate devices: a device for detecting a fire or smoke or gas and another device for detecting whether or not a parking position is occupied.

In particular, now only a single wiring needs to be laid to the sensor device. Thus it is no longer necessary to lay separate wirings to two individual devices.

One specific embodiment provides for the sensor system and the parking sensor to be developed as a common sensor chip.

This achieves in particular the technical advantage that the sensor system and the parking sensor may be produced or manufactured efficiently. It is only necessary to produce a single sensor chip, which has a dual function: detecting fire and/or smoke and/or gas and detecting whether a parking position is free or occupied. It is thus no longer necessary to produce two separate sensors for the two aforementioned tasks or functions.

That is to say in particular that a sensor chip is formed that includes both the sensor system for detecting a fire and/or smoke and/or gas as well as the parking sensor. The sensor chip for example includes multiple sensor surfaces that fulfill the aforementioned functionalities.

The formulation “at least one parking sensor” includes in particular a specific embodiment in which multiple parking sensors are provided. That is to say in particular that according to one specific embodiment the sensor device may have several parking sensors for detecting an occupancy state of a parking position.

The parking sensor is an environment sensor, for example. An environment sensor is for example a radar sensor, lidar sensor, laser sensor, video sensor, magnetic sensor or ultrasonic sensor.

In the case of multiple parking sensors, these may be embodied for example to be identical or different.

One specific embodiment provides for the sensor system to include a temperature sensor.

This achieves in particular the technical advantage of being able to measure a temperature, it being possible in particular to measure an ambient temperature of the sensor device. A fire may thus be reliably detected. For a fire normally results in a highly increased temperature.

Another specific embodiment provides for the sensor system to include a smoke sensor for detecting smoke.

This achieves in particular the technical advantage of being able to detect smoke efficiently. It is thus possible to detect smoke. Thus it is also possible to detect dangerous situations efficiently and reliably in which there is a strong and possibly poisonous formation of smoke without there being at the same time a highly increased temperature.

Another specific embodiment provides for the sensor system to include a gas sensor for measuring gases, in particular vehicle exhaust gases.

This achieves in particular the technical advantage of making it possible to register or measure or detect gases in the surroundings of the sensor device efficiently. It is possible to measure vehicle exhaust gases, in particular.

Thus it is possible to trigger an alarm if a concentration of vehicle exhaust gases exceeds a predetermined threshold value. Vehicle exhaust gases include carbon monoxide, for example.

Another specific embodiment provides for a communication interface that is designed to report an occupancy state of the parking position and/or a detected fire and/or a detected gas and/or detected smoke to a parking lot management server via a communication network.

This yields in particular the technical advantage of being able to inform the parking lot management server efficiently about the occupancy state of the parking position and/or about a detected fire and/or smoke and/or gas. The parking lot management server is thus advantageously able to respond to this in an efficient manner. For example, in the event of a fire and/or smoke and/or gas, the parking lot management server is able to call the fire department and/or inform or warn persons located within the parking lot about the fire or the smoke or the gas.

One specific embodiment provides for the communication interface to report a sensor value of the sensor system via the communication network to the parking lot management server.

A sensor value may be for example a temperature, a smoke intensity, a gas type or a gas concentration. In particular, it is possible to report multiple sensor values.

This yields in particular the technical advantage that additional information is available in order better to be able to assess a concrete critical situation.

The communication network includes for example a WLAN or a mobile communications network.

According to one specific embodiment, the communication interface is developed as a wireless and/or wired communication interface.

Another specific embodiment provides for developing a signaling device for outputting an alarm signal in the event of a detected fire and/or detected smoke and/or detected gas.

This yields in particular the technical advantage of being able to warn efficiently of the detected fire and/or smoke and/or gas. The alarm signal is an acoustic alarm signal, for example. An alarm signal may be in particular an optical alarm signal. The signaling device is in particular able to output both optical as well as acoustic alarm signals.

Another specific embodiment provides for the sensor system and the parking sensor to have a common electrical interface for an electrical voltage supply.

This yields in particular the technical advantage that the sensor system and the parking sensor are able to be connected efficiently to an electrical voltage supply. It is thus sufficient to wire a single electrical voltage supply to the sensor device in order to contact the sensor system and the parking sensor electrically or to supply them with electrical voltage.

According to one specific embodiment, the sensor device includes an electrical storage device for an electrical voltage supply of the sensor system and of the parking sensor. This advantageously achieves an autarkical energy supply of the sensor system and of the parking sensor. The storage device includes for example one or more batteries and/or for example one or more accumulators.

According to one specific embodiment, the electrical storage device is electrically connected to the common electrical interface.

In one specific embodiment, an electrical voltage supply of the sensor system and of the parking sensor is provided by an external electrical voltage source. That is to say that an electrical cable is provided, which is connected to the sensor device and which connects the latter to the external electrical voltage supply.

In one specific embodiment, the sensor device includes the electrical storage device and is connected to the external electrical voltage source via the electrical cable. The electrical storage device is advantageously used here as a redundant voltage supply.

Another specific embodiment provides for the communication interface to be developed as a common communication interface for the sensor system and the parking sensor.

This in particular achieves the technical advantage that both the sensor system as well as the parking sensor are able to use the communication interface efficiently for reporting. In comparison to the case in which the parking sensor and the sensor system each have a separate communication interface, material and manufacturing time are saved in this specific embodiment. Furthermore, in the case of a wired communication interface for example, it may be sufficient to lay only one single communication line to the sensor device.

According to one specific embodiment, the communication interface is developed as a wireless and/or wired communication interface.

According to one specific embodiment, the communication network comprises a wired and/or wireless communication network.

Another specific embodiment provides for a memory for storing a current position of the sensor device in the parking lot and/or for storing an individual identifier of the sensor device, the communication interface being developed so as to report the current position and/or the individual identifier to the parking lot management server in the event of a detected fire and/or detected smoke and/or detected gas.

This yields in particular the technical advantage that the parking lot management server is able to be informed in an efficient manner as to where the fire or the smoke or the gas are located.

Another specific embodiment provides for a housing to be developed, in which the sensor system and the parking sensor are disposed.

This yields in particular the technical advantage that an installation may be further simplified in an efficient manner. In particular, it is advantageously possible to protect the sensor system and the parking sensor against external influence by way of the housing.

This means in particular that the sensor system and the parking sensor are situated in a common housing (or within a common housing) or on a common housing. Thus only one housing needs to be installed in order to mount both a parking sensor as well as a sensor system for detecting a fire and/or smoke and/or gas.

One specific embodiment for example provides for the sensor system and the parking sensor to be developed as a common sensor chip that is situated in the housing.

One specific embodiment provides for the sensor system and the parking sensor to be developed separately from each other. The sensor system and the parking sensor, according to one specific embodiment, are thus developed as two individual sensor systems formed separately from each other. According to one specific embodiment, the two individual sensor systems are situated in the housing.

In one specific embodiment, the electrical storage device is situated within the common housing.

One specific embodiment provides for the sensor device to be situated on a floor area of a parking position.

Another specific embodiment provides for the sensor device to be situated in a floor of the parking position.

Another specific embodiment provides for the sensor device to be situated on a ceiling or in a ceiling of the parking lot.

In another specific embodiment, the parking lot includes multiple sensor devices. These multiple sensor devices may be arranged or mounted identically or differently. In particular, the sensor devices themselves may be designed differently or identically.

A parking lot in the sense of the present invention may also be called a parking area and used as an area for parking vehicles. The parking lot thus forms in particular a contiguous area, which has multiple parking spaces (in the case of a parking lot on private property) or parking stalls (in the case of a parking lot on public property). According to one specific embodiment, the parking lot may be developed as a car park. In particular, the parking lot is developed as a parking garage.

A parking lot in the sense of the present invention includes in particular one or multiple parking positions. These parking positions are thus in particular parking spaces or parking stalls.

The sensor device is assigned in particular to a parking position. That is to say that the parking sensor monitors or detects the occupancy state of the associated parking position.

According to one specific embodiment, the sensor system may include a temperature sensor and/or a smoke detector. In particular, the smoke sensor may comprise an optical or photoelectric measuring device.

According to one specific embodiment, the sensor system may comprise a smoke alarm, in particular an ionization smoke alarm, a fire alarm, a gas alarm, a flame alarm or an alarm of any combination of the aforementioned alarms, that is, for example a combined fire/smoke alarm, generally a combined smoke and/or fire and/or gas and/or flame alarm.

Thus, according to one specific embodiment, the sensor device includes for example a smoke alarm, in particular an ionization smoke alarm, and/or a fire alarm and/or a gas alarm and/or a flame alarm and/or a combined smoke and/or fire and/or gas and/or flame alarm as well as the parking sensor or the multiple parking sensors.

### BRIEF DESCRIPTION OF THE DRAWINGS

The present invention is explained in greater detail below with reference to preferred exemplary embodiments.

FIG. 1 shows a sensor device.

FIG. 2 shows another sensor device.

FIG. 3 shows a parking lot.

### DETAILED DESCRIPTION OF EXAMPLE EMBODIMENTS

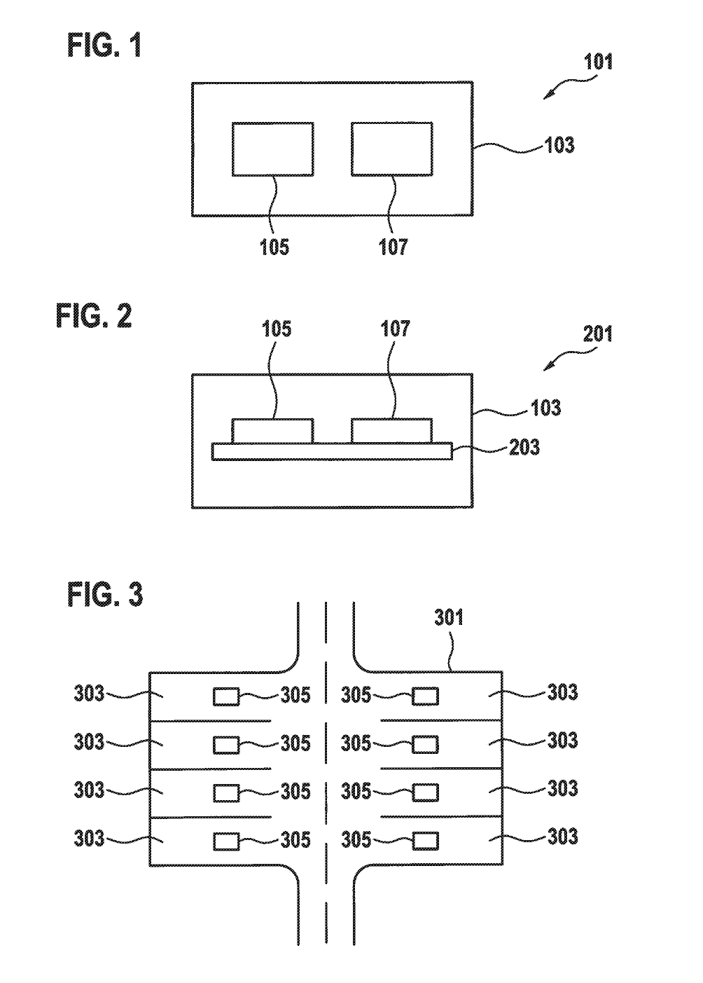

FIG. 1 shows a sensor device 101 for a parking lot.

Sensor device 101 includes a housing 103. Housing 103 accommodates a sensor system for detecting a fire and/or smoke and/or gas. Housing 103 furthermore accommodates a parking sensor 107 for detecting an occupancy state of a parking position.

Sensor system 105 may comprise a temperature sensor and/or a smoke sensor, for example. In particular, the smoke sensor may comprise an optical or photoelectric measuring device.

The sensor device 101 may comprise for example an ionization smoke alarm.

Parking sensor 107 may be a radar sensor, for example. In particular, multiple parking sensors 107 may be provided. Sensor device 101 may comprise an ultrasonic sensor and a radar sensor, for example.

Sensor device 101 may be situated or mounted for example on or in a flooring of a parking position. In particular, it is possible for sensor device 101 to be situated or mounted on or in a facing of a ceiling of a parking lot. This ceiling area is associated in particular with a parking position. The ceiling area may be situated for example opposite the flooring of the parking position.

FIG. 2 shows another sensor device 201 for a parking lot.

Sensor device 201 includes a housing 103. Housing 103 accommodates a sensor chip 203, which comprises sensor system 105 and parking sensor 107. That is to say, sensor system 105 and parking sensor 107 are formed as a common sensor chip, the sensor chip 203.

FIG. 3 shows a parking lot 301.

Parking lot 301 includes multiple parking positions 303. Respectively one sensor device 305 is situated on a flooring of parking position 303. In a specific embodiment that is not shown, sensor devices 305 may be situated in the flooring of the respective parking position 303. Sensor device 305 maybe sensor device 201 from FIG. 2 or sensor device 101 from FIG. 1, for example. Sensor device 305 may comprise in particular a fire alarm.

The present invention thus comprises, in particular and among other things, providing a technical and efficient way by which it is possible to reduce costs that arise in the installation of fire alarms and/or smoke alarms and parking sensors, for example. This is so in particular because the present invention provides one sensor device comprising for example a common sensor chip (parking sensor and sensor system, in particular fire sensor) instead of two separate devices.

In one specific embodiment, the common sensor chip includes the following functions: parking occupancy sensor (parking sensor) and temperature sensor. That is to say that the only variable that is measured is a temperature.

In another specific embodiment, the common sensor chip includes instead of or in addition to the temperature sensor a fire sensor, which is further able to detect in particular smoke.

In another specific embodiment, the common sensor chip may include a gas sensor in order to be able to determine or detect gases. The gases may be vehicle exhaust gases, for example.

According to one specific embodiment, the results of the detection may be transmitted to a parking lot management server, which may be part of a parking lot management system, for example.

The sensor device transmits in particular the information or the results regarding an occupancy state of the parking position to the parking lot management server. In accordance with the transmitted information, the parking lot management server in one specific embodiment may trigger or carry out actions. Actions include for example providing information to a fire department or calling a fire department.

In one specific embodiment, the sensor device is furthermore able to output warning sounds.

The advantage of the embodiments of the present invention is to be seen in particular in the fact that it is necessary for example to manufacture, install and service only one single sensor chip. Accordingly, it is only necessary now to route one single set of wiring, for example.

An additional advantage is to be seen in particular in the fact that a location of the fire and/or gas emission is known with precision since in particular each sensor device is assigned to a predetermined parking position within the parking lot. This in particular because of the fact that the sensor device is situated on a parking area or above the parking area of a parking position. In the case of an automobile that is parked in the parking position, the sensor device is thus situated below or above the parked vehicle.

What is claimed is:

1. A sensor device for a parking lot, comprising:
a sensor system for detecting at least one of: i) a fire, and ii) smoke, and iii) gas; and
at least one parking sensor for detecting an occupancy state of a parking position.

2. The sensor device as recited in claim 1, wherein the sensor system and the parking sensor are formed as a common sensor chip.

3. The sensor device as recited in claim 1, wherein the sensor system and the parking sensor are formed as two individual sensor systems formed so as to be separated from each other.

4. The sensor device as recited in claim 1, wherein the sensor system includes temperature sensor.

5. The sensor device as recited in claim 1, wherein the sensor system includes a smoke sensor for detecting smoke.

6. The sensor device as recited in claim 1, wherein the sensor system includes a gas sensor for measuring vehicle exhaust gases.

7. The sensor device as recited in claim 1, further comprising:
a communication interface designed to report to a parking lot management server via a communication network at least one of: an occupancy state of the parking position, a detected fire, detected smoke, and detected gas.

8. The sensor device as recited in claim 7, wherein the communication interface is designed to report a sensor value of the sensor system via the communication network to the parking lot management server.

9. The sensor device as recited in claim 7, wherein the communication interface is a common communication interface for the sensor system and the parking sensor.

10. The sensor device as recited in claim 7, further comprising:
a memory being developed for storing at least one of: a current position of the sensor device in the parking lot, and an individual identifier of the sensor device, wherein the communication interface is designed to report at least one of: a current position, and the individual identifier, to the parking lot management server in the event of at least one of: a detected fire, detected smoke, and detected gas.

11. The sensor device as recited in claim 1, further comprising:
a signaling device to output an alarm signal in the event of at least one of: a detected fire, detected smoke, and detected gas.

12. The sensor device as recited in claim 1, wherein the sensor system and the parking sensor include a common electrical interface for an electrical voltage supply.

13. The sensor device as recited in claim 1, further comprising:
an electrical storage device for an electrical voltage supply of the sensor system and of the parking sensor.

14. The sensor device as recited in claim 1, further comprising:
a housing in which the sensor system and the parking sensor are situated.

15. A parking lot, including the sensor device including a sensor system for detecting at least one of: i) a fire, and ii) smoke, and iii) gas, and at least one parking sensor for detecting an occupancy state of a parking position.
